(19) United States
(12) Patent Application Publication
(10) Pub. No.: US 2023/0001851 A1
(43) Pub. Date: Jan. 5, 2023

(54) Reading and Table Lighting in Buses

(71) Applicant: Daimler Truck AG, Leinfelden-Echterdingen (DE)

(72) Inventors: Refik Can BASARGAN, Istanbul (TR); Umit SAGLAM, Istanbul (TR)

(21) Appl. No.: 17/642,403

(22) PCT Filed: Sep. 7, 2020
(86) PCT No.: PCT/EP2020/074924

§ 371 Date: Mar. 11, 2022

(30) Foreign Application Priority Data
Sep. 12, 2019 (TR) 2019/13886

(51) Int. Cl. B60Q 3/233; B60Q 3/44; B60N 2/24; B60Q 3/82

(52) U.S. Cl. CPC B60Q 3/233; B60Q 3/44; B60N 2/242; B60Q 3/82

(57) ABSTRACT

A reading/lighting system in a vehicle includes a reading/lighting lamp disposed on a backrest of the vehicle. A reading/lighting area illuminated by the reading/lighting lamp is focused when a table disposed on the backrest of the vehicle is in a use position such that the reading/lighting area illuminates a surface of the table and, when the table is in a non-use position, the reading/lighting area is focused such that the reading/lighting area illuminates a reading area.

### BACKGROUND AND SUMMARY OF THE INVENTION

The present invention relates to reading and table lighting systems in buses.

The invention relates in particular to a reading and table lighting lamp in buses which ensures that the tables on the backrests of the passenger seats are illuminated by the LED lights integrated on the handles on the backrests of the passenger seats in buses and at the same time can be used as a reading lamp.

Although the reading lamps on the ceiling of the buses are considered to be separate for each seat, when in use they illuminate not only the person using them but also the surrounding area.

This situation is bothersome for the passengers sitting on the seats around the light.

Since the lighting is from the ceiling, the light reflected by the windscreen affects the driver, particularly during night driving, and driving comfort and safety are negatively affected.

Since the light intensity cannot be adjusted, passengers' eyes are disturbed by reflections.

Lighting from the ceiling has a negative effect on driving comfort and safety due to the reflection on the windscreen during night driving.

At the same time, the light reflected by the side windows affects the comfort of other passengers.

New technical solutions are needed to remedy this situation.

When lighting from the ceiling, the light intensity cannot be adjusted and the passenger using the reading lamp and the surrounding passengers cannot travel comfortably because of the light.

In current systems, access to control the ceiling reading lights is a problem, especially for disabled passengers and for small passengers such as children.

In existing systems, due to the installation on the air duct, different services have to be performed within the ceiling at different distances depending on the distribution of seats. There is a need for new technical developments in which the installation and preparation of the installation is facilitated and the work required in the event of failure and for replacement processes can be easily performed.

Chinese patent application CN104315402 describes a multi-functional table lamp. The multi-functional table lamp has a bottom seat, a lamp pole and a table lamp body secured to the bottom seat.

A technically different structure is described for use on a table at home.

The object of the invention, proceeding from the known prior art, is to develop a table lighting and reading lamp in which the disadvantages in existing structures are eliminated and which are formed by the integrated LED lamps on the handles on the backrests of the passenger seats in buses.

A further object of the invention is to remove the reflection from the front and side windows by bringing the reading/lighting lamp onto the handles on the backrest.

A further object of the invention is to create a reading lamp of which the light intensity can be adjusted.

A further object of the invention is to provide lighting in the backrest handle which is easily accessible and controllable.

A further object of the invention is to facilitate possible maintenance and replacement by mounting directly on the backrest.

To achieve the above objects, table lamps and reading lamps in buses have been developed.

### BRIEF DESCRIPTION OF THE DRAWINGS

FIG. 1 shows a general view of a representative application of the invention on the backrest.

FIG. 2 shows a detailed view of the handle in a representative application of the invention.

FIG. 3 shows the use on the seats in a representative application of the invention.

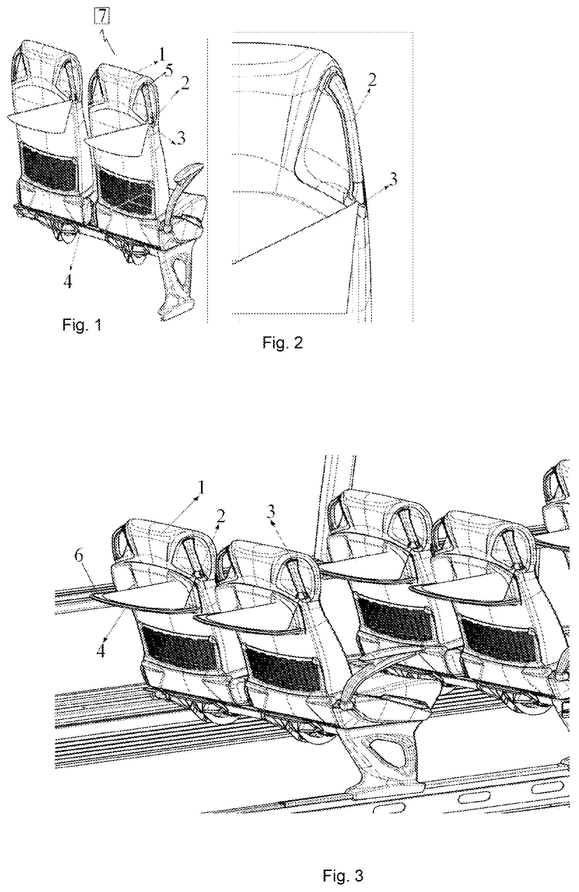

### DETAILED DESCRIPTION OF THE DRAWINGS

In buses according to the invention, the reading lamp system consists of the LED lamps as reading/lighting lamps (3), which are located on the handles (2) integrated in the backrests (1). The reading/lighting lamp (3) is controlled by a button (5) located on the handle (2). The energy required to operate the system is transmitted through the side walls or through the seat connection rail to the seat frames and from the seat frames into the backrests (1) and into the handles (2).

During the assembly of the handles (2), the handle is plugged into the electrical cable. Pressing the button (5) on the handle (2) activates, with a low lighting intensity, the LED lamp serving as a reading/lighting lamp (3), causing the reading/lighting area (4) to be illuminated.

Pressing the button (5) a second time increases the light intensity and provides stronger illumination. Pressing the button (5) a third time switches off the reading/lighting lamp (3).

When the table (6) on the backrest (1) is in use, the reading/lighting area (4) is focused so that it will illuminate the surface of the table (6), and when the table (6) is not in use, it is focused so that it will illuminate the reading area.

The entire system has an on-off control with a switch in the driver's area so that it can be completely deactivated if required.

The system can be used not only in buses but also in all vehicles used to transport passengers, such as trains, trams, etc. The system can be integrated into both the central handles and the side handles (2) mounted on the backrests (1), and it can also be integrated on the handles on corridor or side walls.

The adjustment of the light color of the system and/or the change of the light color in accordance with the control of the light intensity through several stages can be ensured by means of a control unit (7).

Table lighting systems (6) in vehicles, specifically in buses, according to the invention are characterized in that they comprise the reading/lighting lamps (3) for reading and lighting in the reading/lighting areas (4) integrated in the backrests (1) in order to create a reading/lighting system, in which, when the table (6) on the backrest (1) is in use, the reading/lighting area is focused to illuminate the surface of the table (6) and, when the table (6) is not in use, is focused to illuminate the reading area.

Each reading/lighting lamp (3) on the handles (2) integrated on the backrests (1) contains an LED lamp.

It comprises at least one button (5), which is connected to the power cable during the assembly of the handles (2) and which, with a single push, will activate the LED lamp serving as a reading/lighting lamp (3) with low lighting intensity, thus illuminating the reading/lighting area (4), and with a second push will increase the light intensity and thus provide stronger illumination.

It contains a control unit (7) that controls on/off switching with a key in the driver's area so that it can be completely deactivated if required.

It comprises reading/lighting lamps (3) that are integrated next to the side handles (2) that are integrated on the backrests (1) in vehicles that carry passengers, such as buses, trains, trams, and that are also integrated in the central handles as well as in the handles (2) in the corridor and side walls.

It comprises a control unit (7) by means of which the adjustment of the light color of the system and/or by means of which the change, management and control of the light color is ensured in accordance with the control of the light intensity through several stages.

### LIST OF REFERENCE CHARACTERS

1. Seat backrest
2. Handle
3. Reading/lighting lamp
4. Reading/lighting area
5 Button
6. Table
7. Control unit

1.-6. (canceled)

7. A reading/lighting system in a vehicle, comprising:
a reading/lighting lamp disposed on a backrest of the vehicle.

8. The reading/lighting system according to claim 7, wherein a reading/lighting area illuminated by the reading/lighting lamp is focused when a table disposed on the backrest of the vehicle is in a use position such that the reading/lighting area illuminates a surface of the table and wherein when the table is in a non-use position the reading/lighting area is focused such that the reading/lighting area illuminates a reading area.

9. The reading/lighting system according to claim 7, wherein the vehicle is a bus,

10. The reading/lighting system according to claim 7, wherein the reading/lighting lamp is disposed on a handle that is disposed on the backrest and wherein the reading/lighting lamp is an LED lamp.

11. The reading/lighting system according to claim 10, further comprising a button disposed on the handle, wherein the button is connected to a power cable disposed in the handle, wherein the LED lamp is activatable with a low lighting intensity with a first push of the button, and wherein the LED lamp is activatable with a lighting intensity that is greater than the low lighting intensity with a second push of the button.

12. The reading/lighting system according to claim 7, further comprising a control unit, wherein the control unit controls on/off switching of the reading/lighting system with a key in a driver area of the vehicle.

13. The reading/lighting system according to claim 7, wherein the reading/lighting lamp is disposed on a side handle or a central handle disposed on the backrest.

14. The reading/lighting system according to claim 7, wherein the vehicle is a bus or a train or a tram.

15. The reading/lighting system according to claim 7, further comprising a control unit, wherein a color of a light of the reading/lighting lamp and an intensity of the light of the reading/lighting lamp is controllable by the control unit.
